(19) United States
(12) Patent Application Publication
(10) Pub. No.: US 2009/0231186 A1
(43) Pub. Date: Sep. 17, 2009

(54) COMPACT ELECTRONICALLY-STEERABLE MOBILE SATELLITE ANTENNA SYSTEM

(75) Inventors: Ilan Saul Barak, Kfar Saba (IL); Mario Gachev, Sofia (BG); Victor Boyanov, Sofia (BG); Borislav Petkov Marinov, Sofia (BG); Vesselin Peshlov, Pazardzhik (BG); Rossen Stoyanov, Sofia (BG)

Correspondence Address: D. Kligler I.P. Services LTD, P.O. Box 25, Zippori, 17910, IL

(73) Assignee: RAYSAT BROADCASTING CORP., Vienna, VA (US)

(21) Appl. No.: 12/364,532

(22) Filed: Feb. 3, 2009

Related U.S. Application Data
(60) Provisional application No. 61/026,497, filed on Feb. 6, 2008.

(51) Int. Cl. H04B 7/185

(52) U.S. Cl. 342/352

(57) ABSTRACT

A satellite antenna terminal includes a circuit board having first and second opposite surfaces. A plurality of antenna elements are disposed on the first surface of the circuit board and are operative to receive Radio Frequency (RF) signals from a satellite. One or more signal processing devices are disposed on the second surface of the circuit board and are coupled to process the RF signals received by the antenna elements.

### CROSS-REFERENCE TO RELATED APPLICATIONS

This application claims the benefit of U.S. Provisional Patent Application 61/026,497, filed Feb. 6, 2008, whose disclosure is incorporated herein by reference.

### FIELD OF THE INVENTION

The present invention relates generally to satellite communication systems, and particularly to antennas for mobile satellite terminals.

### BACKGROUND OF THE INVENTION

Satellite communication systems are used for providing various types of communication services, such as television or other video services, voice communication services, data communication services such as Internet access, and many others. For example, Direct Broadcast Satellite (DBS) systems transmit digitally-compressed television and audio signals to subscriber terminals.

Various methods and systems are known in the art for providing satellite communication services to mobile terminals. For example, Raysat, Inc. (Vienna, Va.) offers a family of mobile satellite terminals called SpeedRay™. KVH Industries, Inc. (Middletown, R.I.) offers a line of mobile satellite terminals called TrackVision®.

U.S. Pat. No. 6,999,036, whose disclosure is incorporated herein by reference, describes an antenna system that includes a plurality of antenna arrangements. The antenna arrangements form a spatial phased array able to track a satellite in an elevation plane by mechanically rotating the arrangements. A combining/splitting circuit provides phasing and signal delay in order to maintain preconfigured radiating parameters. The arrangements can be mounted on a rotating platform to provide azimuth tracking. The system provides dynamic tracking of satellite signals and can be used for satellite communications on moving vehicles. Yet another mobile satellite antenna system is described in U.S. Patent Application Publication 2008/0129624, whose disclosure is incorporated herein by reference.

### SUMMARY OF THE INVENTION

An embodiment of the present invention provides a satellite antenna terminal, including:

a circuit board having first and second opposite surfaces;

a plurality of antenna elements, which are disposed on the first surface of the circuit board and are operative to receive Radio Frequency (RF) signals from a satellite; and

one or more signal processing devices, which are disposed on the second surface of the circuit board and are coupled to process the RF signals received by the antenna elements.

In some embodiments, the signal processing devices include Monolithic Microwave Integrated Circuits (MMICs). In an embodiment, each of the signal processing devices is coupled to accept one or more of the received RF signals at an input frequency, and to produce an output RF signal at an output frequency that is equal to the input frequency. In another embodiment, each of the signal processing devices is arranged to process four of the received RF signals.

In a disclosed embodiment, the antenna elements include dual-port antenna elements, each operative to receive and output two RF signal components having mutually-orthogonal polarizations. In another embodiment, the antenna elements include first and second sets of the antenna elements, which are operative to receive and output respective first and second RF signal components having first and second mutually-orthogonal polarizations.

In some embodiments, the signal processing devices are coupled to modify relative amplitudes and phases of the RF signals received by the antenna elements, and to combine the RF signals having the modified relative amplitudes and phases to produce a combined output signal. In an embodiment, the signal processing devices are coupled to modify a radiation pattern formed by the antenna elements. The signal processing devices may be coupled to electronically steer an antenna beam formed by the antenna elements. Additionally or alternatively, the signal processing devices may be coupled to modify a polarization inclination angle of the radiation pattern. In an embodiment, the signal processing devices are configurable to switch between receiving circularly-polarized RF signals and linearly-polarized RF signals.

In a disclosed embodiment, the terminal further includes Low-Noise Amplifiers (LNAs), which are disposed on the second surface and are operative to amplify the RF signals received by the antenna elements and to provide the amplified RF signals to the signal processing devices, and the signal processing devices include biasing circuits for biasing the LNAs. In another embodiment, the terminal includes a metallic chassis on which the circuit board is mounted, and the chassis includes multiple protrusions that extend toward the circuit board and come to thermally-conductive contact with the signal processing devices.

In yet another embodiment, the circuit board includes a multi-layer Printed Circuit Board (PCB). In still another embodiment, the terminal includes at least one additional component, which is disposed on the second surface and is selected from a group of components consisting of a Central Processing Unit (CPU), a Low-Noise Amplifier (LNA), a down-converter, a power supply, a Global Positioning System (GPS) receiver and a gyro sensor. In another embodiment, a total height of the terminal, in a dimension perpendicular to a plane of the circuit board, does not exceed 3 cm.

There is additionally provided, in accordance with an embodiment of the present invention, a method for producing a satellite antenna terminal, the method including:

disposing a plurality of antenna elements for receiving Radio Frequency (RF) signals from a satellite on a first surface of a circuit board; and

disposing one or more signal processing devices for processing the RF signals received by the antenna elements on a second surface of the circuit board, which is opposite the first surface.

The present invention will be more fully understood from the following detailed description of the embodiments thereof, taken together with the drawings in which:

### BRIEF DESCRIPTION OF THE DRAWINGS

FIG. 1 is an exploded view of a mobile satellite antenna system, in accordance with an embodiment of the present invention;

FIG. 2 is a vertical cross section of a mobile satellite antenna system, in accordance with an embodiment of the present invention;

FIG. 3 is a block diagram that schematically illustrates a mobile satellite antenna system, in accordance with an embodiment of the present invention;

FIG. 4 is an illustrative vertical cross section of a mobile satellite antenna system, in accordance with an embodiment of the present invention; and

FIG. 5 is a vertical cross section of an antenna assembly in a mobile satellite antenna system, in accordance with an embodiment of the present invention.

### DETAILED DESCRIPTION OF EMBODIMENTS

### Overview

Embodiments of the present invention provide improved phased array antenna systems for receiving communication signals from satellites. The disclosed antenna systems are particularly suitable for mobile satellite terminals installed in vehicles.

In some embodiments, an antenna system comprises a plurality of antenna elements, which receive Radio Frequency (RF) signals from a satellite. The RF signals received by the antenna elements are processed by one or more signal processing devices. The signal processing devices typically adjust the relative phases and amplitudes of the received RF signals, so as to steer the antenna beam toward the satellite. Additionally, the signal processing devices can also control the polarization inclination of the antenna to match the polarization of the satellite signal.

In the disclosed antenna systems, the antenna elements are disposed on one surface of a circuit board, and the signal processing devices are disposed on the opposite surface of the board. This mechanical configuration reduces the overall height of the antenna system (the dimension perpendicular to the circuit board). The reduced height simplifies the installation of the antenna system in a vehicle, and may enable higher flexibility in choosing the installation location. Moreover, disposing the antenna elements and signal processing devices on opposite surfaces of the same circuit board typically reduces the number of circuit boards, and the number of interconnections between circuit boards. A simpler mechanical structure having fewer boards and interconnections typically means lower signal losses, higher reliability and lower cost.

### System Description

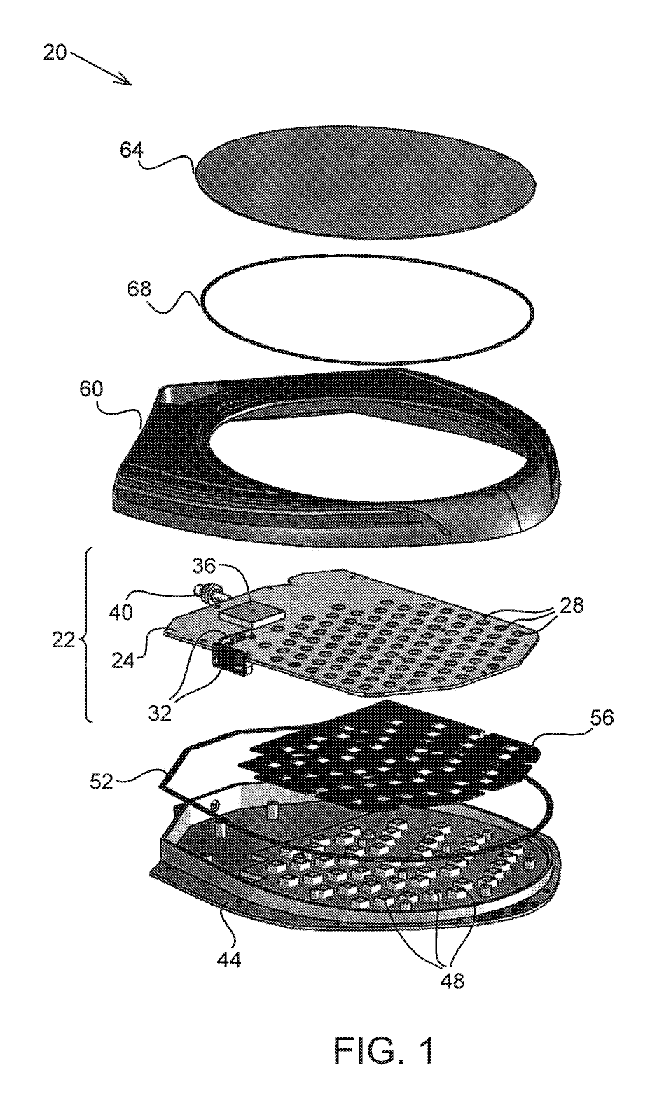

FIG. 1 is an exploded view of a mobile satellite antenna system 20, in accordance with an embodiment of the present invention. System 20 comprises an electronically-steerable phased array antenna for tracking and receiving communication signals from satellites. The system is designed for installation in vehicles, and is able to steer the radiation pattern of the phased array antenna toward the satellite while compensating for vehicle motion.

System 20 has a flat and compact mechanical profile that is particularly suitable for mounting in vehicles, such as cars, buses, Recreational Vehicles (RVs), trains, boats or airplanes. In the present example, system 20 receives satellite signals in the KU band, e.g., in the range 12.2-12.7 GHz, although any other suitable frequency bands, such as the KA band, can also be used.

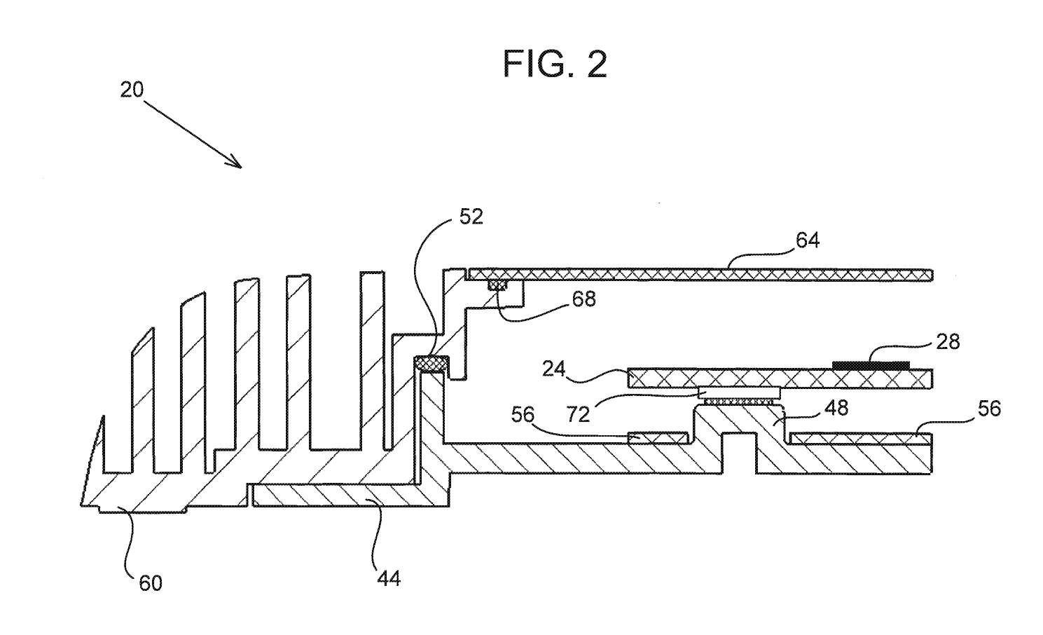

System 20 comprises an antenna assembly 22. Assembly 22 comprises a circuit board 24, which has two opposite surfaces. Multiple antenna elements 28 are disposed on one surface of the circuit board. One or more signal processing devices (not shown in this figure) are disposed on the opposite surface of the circuit board. The antenna elements receive signals from a satellite, and the signal processing elements process the received signals using methods that are addressed below. Cross sections showing the antenna elements and signal processing devices on the opposite surfaces of the circuit board are shown in FIGS. 2, 4 and 5. The example antenna system of FIG. 1 comprises ninety-four printed patch elements that are arranged in a hexagonal grid. In alternative embodiments, however, the antenna system may comprise any other number or type of antenna elements in any desired geometrical arrangement.

In addition to the antenna elements and the signal processing devices, assembly 22 further comprises gyro sensors 32 for sensing the movements of system 20, and a GPS receiver 36 for measuring the geographical coordinates of system 20. The information provided by the gyro sensors and GPS receiver are used for steering the radiation pattern of the phased array antenna toward the satellite. A coaxial connector 40 is used for outputting the received signal produced by the signal processing devices out of system 20, as well as for supplying electrical power and control commands to system 20.

Assembly 22 is mounted on a metallic, mechanical chassis 44. The chassis comprises multiple protrusions 48, which absorb heat that is produced by the signal processing devices and dissipate it to the chassis. When system 20 is packaged, protrusions 48 come to mechanical contact with the signal processing devices on the bottom surface of circuit board 24. This feature is shown in detail in FIG. 2 below. A sealing ring 52 seals the gap between circuit board 24 and chassis 44. A sheet 56 of radiation absorbing material is placed on the bottom of chassis 44 in order to prevent RF radiation from being reflected from the chassis toward assembly 22.

Assembly 22 is covered by a metallic cover 60, which also comprises heat sink fins for additional heat dissipation. Cover 60 has an opening above the antenna elements. A radome 64 is placed over the opening, and a sealing ring 68 seals the contact between the radome and the opening in cover 60.

In the present example, the horizontal aperture of the phased array antenna has a typical diameter in the range of 20-40 cm, and in some implementations less than 20 cm. The height dimension of antenna system 20 (the dimension perpendicular to the plane of circuit board 24) is typically in the range of 2.5-3 cm. In alternative embodiments, however, any other suitable dimensions can be used.

FIG. 2 shows a partial vertical cross section of system 20, in accordance with an embodiment of the present invention. The figure shows the different structural elements of system 20 that were shown in FIG. 1 above. In particular, FIG. 2 shows one of antenna elements 28 disposed on one surface of circuit board 24, and an Analog Signal Processing (ASP) device 72 disposed on the opposite surface of the circuit board. The ASP device is in contact with one of protrusions 48, in this example by means of thermo-conductive grease or a thermo-conductive pad fitted between the ASP device and protrusion 48.

The mechanical configuration shown in FIGS. 1 and 2 is an exemplary configuration, which is shown purely for the sake of conceptual clarity. In alternative embodiments, system 20 may have any other suitable mechanical configuration, in which the antenna elements and the signal processing devices are disposed on opposite surfaces of a circuit board. Alternative configurations are shown in U.S. Provisional Patent Application 61/026,497, cited above.

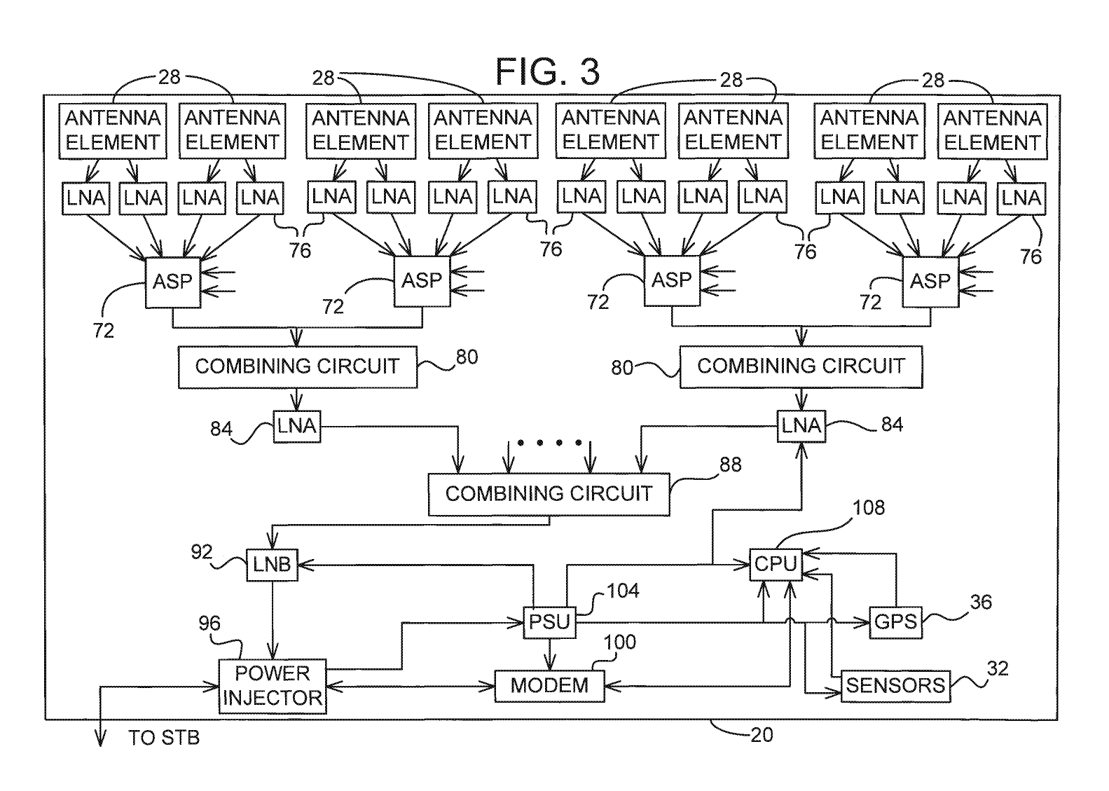

FIG. 3 is a block diagram that schematically illustrates mobile satellite antenna system 20, in accordance with an embodiment of the present invention. FIG. 3 shows the different electronic components comprised in assembly 22 and their interconnections. In the example of FIG. 3, each antenna element 28 comprises a dual-port element, which comprises two outputs that produce two mutually-orthogonal signal components received by the antenna element. The outputs of the different antenna elements are amplified by Low-Noise Amplifiers (LNAs) 76. The outputs of the LNAs are processed by Analog Signal Processing (ASP) devices 72, which apply signal processing operations such as phase shifting, variable attenuation and summation to the signals received by the antenna elements.

In some embodiments, LNAs 76 are internal to the ASP devices. In some embodiments, ASP devices 72 comprise biasing circuitry for biasing LNAs 76. Typically, the ASP devices do not perform frequency conversion operations. In other words, each ASP device receives as input one or more RF signals and produces an output signal having the same frequency as the input signals.

In a typical implementation, each ASP device 72 comprises a Monolithic Microwave Integrated Circuit (MMIC) that processes four signals received by two dual-port antenna elements. The MMICs may be fabricated on any suitable semiconductor substrate, such as Gallium-Arsenide (GaAs) or Silicon-Germanium (SiGe). The MMICs may be packaged in Multi-Chip-Modules (MCMs), which also comprise control and/or biasing circuits. ASP devices of this sort are described, for example, in U.S. patent application Ser. No. 12/354,024, entitled “Analog Signal Processing Device for Phased Array Antennas,” filed Jan. 15, 2009, which is assigned to the assignee of the present patent application and whose disclosure is incorporated herein by reference. In alternative embodiments, system 20 may process the signals received by the antenna elements using any other suitable kind of analog signal processing devices. Each such device may apply any suitable signal processing operation and may be assigned to process any suitable number of signals.

ASPs 72 comprise components such as configurable phase shifters and gain stages (e.g. attenuators), using which the relative phases and amplitudes of the different signals received by antenna elements 28 can be adjusted. By performing these phase and amplitude adjustments, system 20 can steer its radiation pattern (and in particular its antenna beam or main lobe) electronically in any desired direction, in order to point toward the satellite.

Moreover, since elements 28 comprise dual-port elements that receive signal components having mutually-orthogonal polarizations, appropriate phase and amplitude adjustments enable system 20 to receive satellite signals having any desired polarization, such as vertical polarization, horizontal polarization, linear polarization that is tilted at any desired angle, Right-Hand Circular Polarization (RHCP) or Left-Hand Circular Polarization (LHCP). In alternative embodiments, elements 28 may comprise single-port antenna elements. In these cases, some of the elements are oriented on board 24 so to receive a given polarization, and other elements are oriented so as to receive the orthogonal polarization. In other words, ASP devices 72 may obtain the mutually-orthogonal signal components either from dual-port antenna elements or from single-port antenna elements.

The outputs of ASP devices 72 are combined by combining circuits 80 and 88, and may be amplified by LNAs 84. The combined output of the different ASP devices is provided at the output of combining circuit 88. When the appropriate phase shifts and attenuations are applied in ASP devices 72, the radiation pattern formed by elements 28 is pointed toward the satellite, and the signal at the output of combining circuit 88 represents the signal transmitted from the satellite with a high Signal-to-Noise Ratio (SNR).

The signal produced by combining circuit 88 is down-converted to a lower frequency (to L-band in the present example) by a Low-Noise down-converter Block (LNB) 92. The down-converted signal is output on connector 40 (see FIG. 1) via a power injector 96. The signal is provided for further processing by a Set-Top Box (STB—not shown in the figures), which is typically mounted inside the vehicle.

System 20 further comprises a control modem 100, which receives from the STB control commands for controlling the different elements of system 20. In some embodiments, the commands are produced by a modem in the STB and are sent over the same cable used for providing the down-converted signal to the STB. In addition, the same cable can also be used for supplying electrical power from the STB to system 20. Power injector 96 receives the different signals (down-converted signal to the STB, control commands from the STB and electrical power from the STB) separates them and forwards each signal to its proper destination. Typically, the STB comprises a similar power injector at the other end of the cable.

System 20 comprises a Power Supply (PSU) 104, which receives the electrical power from the STB and produces the appropriate voltages for powering the different elements of system 20. A Central Processing Unit (CPU) 108 manages and controls the different system elements, at least partially in response to commands received by modem 100 and to information produced by gyro sensors 32 and GPS receiver 36.

In the present example, the different components of system 20 are mounted on a single circuit board. Alternatively, however, the components can be divided among any suitable number of circuit boards or modules. An example configuration, in which the components are divided between two printed circuit boards, is described in U.S. Provisional Patent Application 61/026,497, cited above.

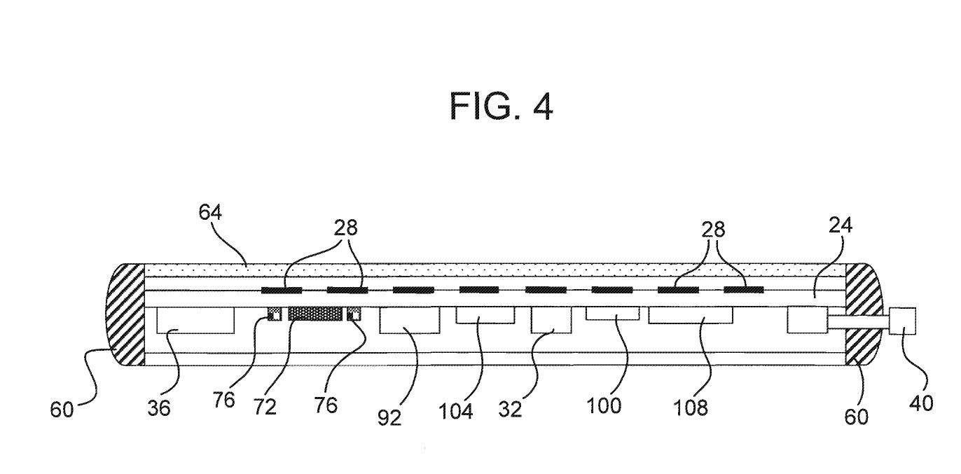

FIG. 4 is an illustrative vertical cross section of system 20, in accordance with an embodiment of the present invention. FIG. 4 shows circuit board 24 with multiple antenna elements 28 disposed on one of its surfaces. ASP devices 72, as well as LNAs 76, GPS receiver 36, gyro sensors 32, LNB 92, PSU 104, control modem 100, CPU 108 and output connector 40, are mounted on the opposite surface of board 24.

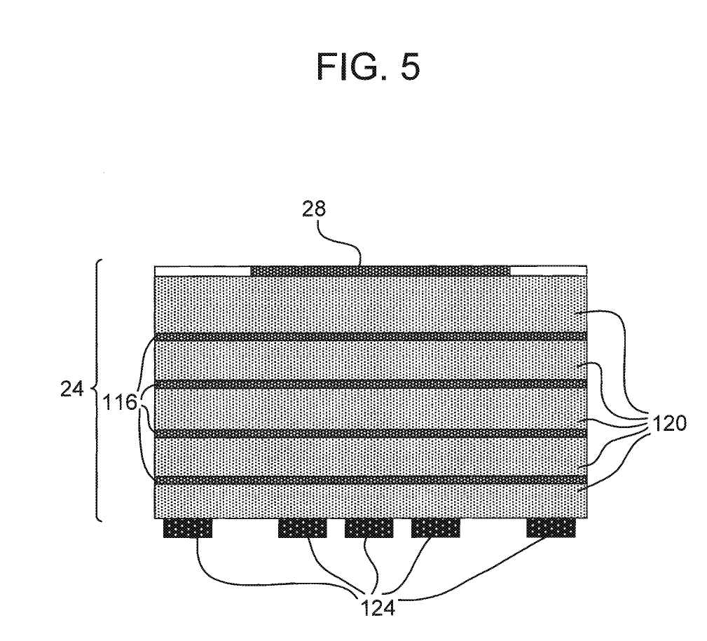

FIG. 5 is a vertical cross section of antenna assembly 22 in system 20, in accordance with an embodiment of the present invention. In this embodiment, circuit board 24 comprises a multi-layer Printed circuit Board (PCB), which comprises multiple conducting layers 116 that are separated by dielectric layers 120. One of antenna elements 28, in this example a printed patch element, is shown on the top surface of the PCB. Conducting layers 116 in this configuration comprise (progressing down from element 28) a ground layer, an interconnection layer comprising microstrip lines, another ground layer and an additional interconnection layer. As noted above, conductive layers 116 are separated by dielectric layers 120.

Interconnections between the different conducting layers of the multi-layer PCB (e.g., interconnections between antenna elements 28 and LNAs 76) may be implemented using any suitable technique, such as using plated via holes (not shown) that traverse the PCB.

Electronic components 124 are disposed on the bottom surface of board 24 (the surface opposite to the surface on which the antenna elements are disposed). Components 124 may comprise, for example, gyro sensors 32, GPS receiver 36, ASP devices 72, LNAs 76, LNB 92, control modem 100, PSU 104 and/or CPU 108.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A satellite antenna terminal, comprising:
a circuit board having first and second opposite surfaces;
a plurality of antenna elements, which are disposed on the first surface of the circuit board and are operative to receive Radio Frequency (RF) signals from a satellite; and
one or more signal processing devices, which are disposed on the second surface of the circuit board and are coupled to process the RF signals received by the antenna elements.

2. The terminal according to claim 1, wherein the signal processing devices comprise Monolithic Microwave Integrated Circuits (MMICs).

3. The terminal according to claim 1, wherein each of the signal processing devices is coupled to accept one or more of the received RF signals at an input frequency, and to produce an output RF signal at an output frequency that is equal to the input frequency.

4. The terminal according to claim 1, wherein each of the signal processing devices is arranged to process four of the received RF signals.

5. The terminal according to claim 1, wherein the antenna elements comprise dual-port antenna elements, each operative to receive and output two RF signal components having mutually-orthogonal polarizations.

6. The terminal according to claim 1, wherein the antenna elements comprise first and second sets of the antenna elements, which are operative to receive and output respective first and second RF signal components having first and second mutually-orthogonal polarizations.

7. The terminal according to claim 1, wherein the signal processing devices are coupled to modify relative amplitudes and phases of the RF signals received by the antenna elements, and to combine the RF signals having the modified relative amplitudes and phases to produce a combined output signal.

8. The terminal according to claim 1, wherein the signal processing devices are coupled to modify a radiation pattern formed by the antenna elements.

9. The terminal according to claim 8, wherein the signal processing devices are coupled to electronically steer an antenna beam formed by the antenna elements.

10. The terminal according to claim 8, wherein the signal processing devices are coupled to modify a polarization inclination angle of the radiation pattern.

11. The terminal according to claim 1, wherein the signal processing devices are configurable to switch between receiving circularly-polarized RF signals and linearly-polarized RF signals.

12. The terminal according to claim 1, and comprising Low-Noise Amplifiers (LNAs), which are disposed on the second surface and are operative to amplify the RF signals received by the antenna elements and to provide the amplified RF signals to the signal processing devices, wherein the signal processing devices comprise biasing circuits for biasing the LNAs.

13. The terminal according to claim 1, and comprising a metallic chassis on which the circuit board is mounted, wherein the chassis comprises multiple protrusions that extend toward the circuit board and come to thermally-conductive contact with the signal processing devices.

14. The terminal according to claim 1, wherein the circuit board comprises a multi-layer Printed Circuit Board (PCB).

15. The terminal according to claim 1, and comprising at least one additional component, which is disposed on the second surface and is selected from a group of components consisting of a Central Processing Unit (CPU), a Low-Noise Amplifier (LNA), a down-converter, a power supply, a Global Positioning System (GPS) receiver and a gyro sensor.

16. The terminal according to claim 1, wherein a total height of the terminal, in a dimension perpendicular to a plane of the circuit board, does not exceed 3 cm.

17. A method for producing a satellite antenna terminal, the method comprising:
disposing a plurality of antenna elements for receiving Radio Frequency (RF) signals from a satellite on a first surface of a circuit board; and
disposing one or more signal processing devices for processing the RF signals received by the antenna elements on a second surface of the circuit board, which is opposite the first surface.
